(19) United States
(12) Patent Application Publication
(10) Pub. No.: US 2017/0363915 A1
(43) Pub. Date: Dec. 21, 2017

(54) LIQUID CRYSTAL DISPLAY DEVICE

(71) Applicant: SAMSUNG DISPLAY CO., LTD., Yongin-si (KR)

(72) Inventors: Donghan SONG, Hwaseong-si (KR); Dongchul SHIN, Seoul (KR); Kichul SHIN, Seongnam-si (KR); Hokil OH, Seoul (KR)

(21) Appl. No.: 15/436,406

(22) Filed: Feb. 17, 2017

(30) Foreign Application Priority Data
Jun. 17, 2016 (KR) 10-2016-0075583

(51) Int. Cl. G02F 1/1343; G02F 1/1333; G02F 1/1368; G02F 1/1362; G02F 1/1335

(52) U.S. Cl. CPC G02F 1/134309; G02F 1/136286; G02F 1/133528; G02F 1/133621; G02F 1/13439; G02F 1/136209; G02F 1/1368; G02F 1/133345; G02F 1/136227; G02F 2001/133548; G02F 2001/133614; G02F 2001/136222; G02F 2201/121; G02F 2201/123

(57) ABSTRACT

A liquid crystal display (LCD) device is capable of improving liquid crystal controllability and light transmittance, the LCD device including: a first substrate including a light emission area and a light blocking area; a switching element on the first substrate, the switching element connected to a gate line and a data line; a first insulating layer on the gate line, the data line, and the switching element; a polarization pattern disposed on the first insulating layer and connected to the switching element through a contact hole of the first insulating layer; and a pixel electrode connected to the polarization pattern in the light emission area.

This application claims priority to Korean Patent Application No. 10-2016-0075583, filed on Jun. 17, 2016, and all the benefits accruing therefrom under 35 U.S.C. §119, the content of which in their entirety is herein incorporated by reference.

### BACKGROUND

### 1. Field

Exemplary embodiments of the invention relate to a display device, and more particularly, to a liquid crystal display (LCD) device capable of improving liquid crystal controllability and light transmittance.

### 2. Description of the Related Art

LCD devices are one of the most widely used types of flat panel display (FPD) devices. An LCD device generally includes two substrates including two electrodes formed thereon and a liquid crystal layer interposed therebetween.

Upon applying voltage to the two electrodes, liquid crystal molecules of the liquid crystal layer are rearranged such that an amount of transmitted light is controlled in the LCD device. To this end, an LCD device requires a backlight unit to provide light.

A great portion of the light provided from the backlight unit may be lost, due to reflection or absorption, while passing through a polarization plate, a liquid crystal layer, and a color filter of the LCD device. In general, only about 3% to about 10% of the light emitted from the backlight unit may be utilized to display an image.

It is to be understood that this background of the technology section is intended to provide useful background for understanding the technology, and as such disclosed herein, the technology background section may include ideas, concepts or recognitions that were not part of what was known or appreciated by those skilled in the pertinent art prior to a corresponding effective filing date of subject matter disclosed herein.

### SUMMARY

Exemplary embodiments of the invention are directed to a liquid crystal display (LCD) device capable of improving liquid crystal controllability and light transmittance.

According to an exemplary embodiment of the invention, a liquid crystal display device includes: a first substrate including a light emission area and a light blocking area; a switching element on the first substrate, the switching element connected to a gate line and a data line; a first insulating layer on the gate line, the data line, and the switching element; a polarization pattern disposed on the first insulating layer and connected to the switching element through a contact hole of the first insulating layer; and a pixel electrode connected to the polarization pattern in the light emission area.

A portion of an upper surface of the polarization pattern contacting the pixel electrode may have a larger area than an area of a portion of the polarization pattern not contacting the pixel electrode.

A contacting area between the polarization pattern and the pixel electrode may be larger than a contacting area between the polarization pattern and the switching element.

The contacting area between the polarization pattern and the pixel electrode may be at least two times the contacting area between the polarization pattern and the switching element.

The polarization pattern may be disposed between the first insulating layer and the pixel electrode.

The polarization pattern may include a plurality of polarization lines spaced apart from one another.

The pixel electrode may overlap the plurality of polarization lines.

The pixel electrode may contact the plurality of polarization lines.

The liquid crystal display device may be defined with a hole that is defined by being surrounded by adjacent ones of the polarization lines, the first insulating layer, and the pixel electrode.

The liquid crystal display device may further include a second insulating layer in the hole.

The second insulating layer and the first insulating layer may be unitary.

At least one of the plurality of polarization lines may be connected to the switching element.

The liquid crystal display device may further include a connecting electrode connecting adjacent ones of the polarization lines.

The plurality of polarization lines may be substantially parallel to the data line.

The liquid crystal display device may further include at least one of: a color filter between the first substrate and the first insulating layer; and a color conversion layer between the color filter and the first insulating layer.

The liquid crystal display device may further include: a second substrate spaced apart from the first substrate; and a liquid crystal layer between the first substrate and the second substrate.

The liquid crystal layer may include a chiral dopant.

A multiplication of a cell gap between the first substrate and the second substrate by a dielectric anisotropy of the liquid crystal layer may be in a range of about 270 nanometers (nm) to about 450 nm.

A ratio of a cell gap between the first substrate and the second substrate to a pitch of the liquid crystal layer may be in a range of about 0.20 to about 0.35.

The liquid crystal display device may further include a backlight unit generating light. The second substrate may be disposed between the first substrate and the backlight unit.

The backlight unit may include one of a white light source emitting white light and a blue light source emitting blue light.

The pixel electrode may include: at least two planar electrodes; and a main connecting electrode connecting adjacent ones of the planar electrodes.

The main connecting electrode may have a smaller area than an area of the planar electrode.

The pixel electrode may further include: at least one auxiliary electrode having a smaller area than an area of the planar electrode and substantially a same length as a length of the planar electrode; and an auxiliary connecting electrode connecting the auxiliary electrode and the planar electrode.

The auxiliary connecting electrode may have a smaller area than an area of the auxiliary electrode.

According to an exemplary embodiment of the invention, a liquid crystal display device includes: a first substrate and a second substrate spaced apart from each other; a liquid crystal layer between the first substrate and the second substrate; a switching element and a pixel electrode on the first substrate, the pixel electrode connected to the switching element; a color conversion layer on the second substrate; an insulating layer on the color conversion layer; a polarization pattern on the insulating layer; and a common electrode connected to the polarization pattern.

The common electrode may be disposed between the polarization pattern and the liquid crystal layer.

A portion of an upper surface of the polarization pattern contacting the common electrode may have a larger area than an area of a portion of the polarization pattern not contacting the common electrode.

The polarization pattern may include a plurality of polarization lines spaced apart from one another.

The liquid crystal display device may be defined with a hole that is defined by being surrounded by adjacent ones of the polarization lines, the insulating layer, and the common electrode.

The liquid crystal display device may further include a backlight unit generating light. The first substrate may be disposed between the second substrate and the backlight unit.

The foregoing is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The above and other features and aspects of the present disclosure of invention will be more clearly understood from the following detailed description taken in conjunction with the accompanying drawings, in which:

FIG. 1 is a plan view illustrating an exemplary embodiment of a liquid crystal display (LCD) device;

FIG. 2 is a cross-sectional view illustrating an exemplary embodiment taken along line I-I′ of FIG. 1;

FIGS. 3A, 3B, 3C, and 3D are views illustrating various shapes of a pixel electrode;

FIG. 4A is a cross-sectional view illustrating an alternative exemplary embodiment taken along line I-I′ of FIG. 1;

FIG. 4B is a cross-sectional view illustrating another alternative exemplary embodiment taken along line I-I′ of FIG. 1;

FIG. 4C is a cross-sectional view illustrating still another alternative exemplary embodiment taken along line I-I′ of FIG. 1;

FIG. 5 is a plan view illustrating an exemplary embodiment of a plurality of pixels;

FIG. 6 is a plan view illustrating an alternative exemplary embodiment of an LCD device;

FIG. 7 is a cross-sectional view taken along line I-I′ of FIG. 6;

FIG. 8 is a plan view illustrating an alternative exemplary embodiment of a polarization pixel electrode;

FIG. 9 is a plan view illustrating an alternative exemplary embodiment of a plurality of pixels;

FIG. 10 is a view illustrating movement of liquid crystals based on a pixel voltage;

FIG. 11 is a view illustrating a light transmittance of a pixel electrode based on the pixel voltage;

FIG. 12 is a view illustrating comparison between respective light transmittances of a reference pixel electrode and a first pixel electrode;

FIG. 13 is a view illustrating comparison between respective light transmittances of the reference pixel electrode and a second pixel electrode;

FIG. 14 is a view illustrating a light transmittance based on a shape of the pixel electrode and a rubbing process of an alignment layer; and

FIG. 15 is a cross-sectional view illustrating an alternative exemplary embodiment of an LCD device.

### DETAILED DESCRIPTION

Advantages and features of the invention and methods for achieving them will be made clear from exemplary embodiments described below in detail with reference to the accompanying drawings. The invention may, however, be embodied in many different forms and should not be construed as being limited to the exemplary embodiments set forth herein. Rather, these exemplary embodiments are provided to help convey the scope of the invention to those skilled in the art. The invention is merely defined by the scope of the claims. Therefore, well-known constituent elements, operations and techniques are not described in detail in the exemplary embodiments in order to prevent the invention from being obscurely interpreted. Like reference numerals refer to like elements throughout the specification.

In the drawings, certain elements or shapes may be illustrated in an enlarged manner or in a simplified manner to better illustrate the invention, and other elements present in an actual product may also be omitted. Thus, the drawings are intended to facilitate the understanding of the present invention.

When a layer, area, or plate is referred to as being “on” another layer, area, or plate, it may be directly on the other layer, area, or plate, or intervening layers, areas, or plates may be present therebetween. Conversely, when a layer, area, or plate is referred to as being “directly on” another layer, area, or plate, intervening layers, areas, or plates may be absent therebetween. Further when a layer, area, or plate is referred to as being “below” another layer, area, or plate, it may be directly below the other layer, area, or plate, or intervening layers, areas, or plates may be present therebetween. Conversely, when a layer, area, or plate is referred to as being “directly below” another layer, area, or plate, intervening layers, areas, or plates may be absent therebetween.

The spatially relative terms “below”, “beneath”, “less”, “above”, “upper”, and the like, may be used herein for ease of description to describe the relations between one element or component and another element or component as illustrated in the drawings. It will be understood that the spatially relative terms are intended to encompass different orientations of the device in use or operation, in addition to the orientation depicted in the drawings. For example, in the case in which a device shown in the drawing is turned over, the device positioned “below” or “beneath” another device may be placed “above” another device. Accordingly, the illustrative term “below” may include both the lower and upper positions. The device may also be oriented in the other direction, and thus, the spatially relative terms may be interpreted differently depending on the orientations.

Throughout the specification, when an element is referred to as being “connected” to another element, the element is “directly connected” to the other element, or “electrically connected” to the other element with one or more intervening elements interposed therebetween. It will be further understood that the terms “comprises,” “comprising,” “includes” and/or “including,” when used in this specification, specify the presence of stated features, integers, steps, operations, elements, and/or components, but do not preclude the presence or addition of one or more other features, integers, steps, operations, elements, components, and/or groups thereof.

It will be understood that, although the terms “first,” “second,” “third,” and the like may be used herein to describe various elements, these elements should not be limited by these terms. These terms are only used to distinguish one element from another element. Thus, “a first element” discussed below could be termed “a second element” or “a third element,” and “a second element” and “a third element” can be termed likewise without departing from the teachings herein.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value.

Unless otherwise defined, all terms used herein (including technical and scientific terms) have a same meaning as commonly understood by those skilled in the art to which this invention pertains. It will be further understood that terms, such as those defined in commonly used dictionaries, should be interpreted as having a meaning that is consistent with their meaning in the context of the relevant art and will not be interpreted in an ideal or excessively formal sense unless clearly defined in the present specification.

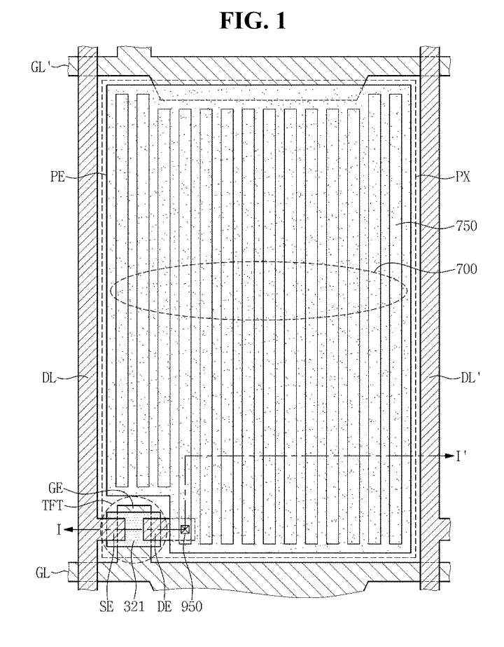

Hereinafter, an exemplary embodiment of a liquid crystal display (LCD) device will be described in detail with reference to FIGS. 1 to 15.

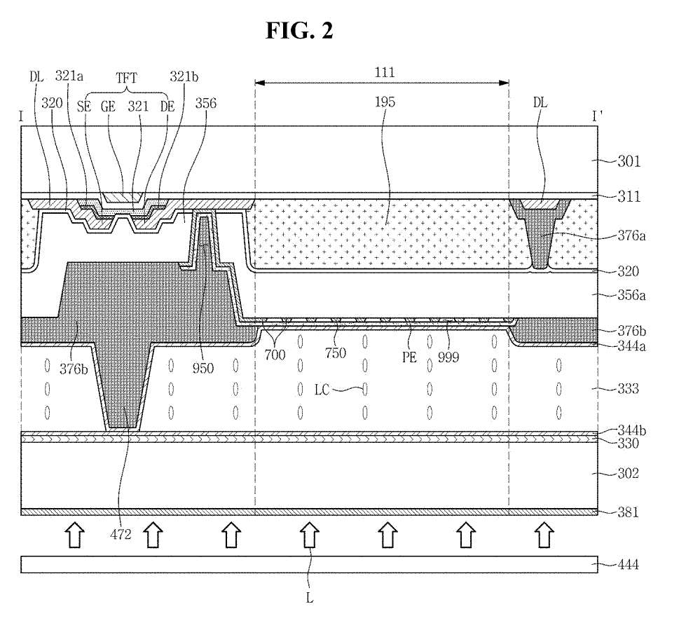

FIG. 1 is a plan view illustrating an exemplary embodiment of an LCD device, and FIG. 2 is a cross-sectional view illustrating an exemplary embodiment taken along line I-I′ of FIG. 1.

An exemplary embodiment of an LCD device includes a plurality of pixels PX and a backlight unit 444.

As illustrated in FIGS. 1 and 2, a pixel PX includes an upper substrate (hereinafter, a first substrate) 301, a switching element TFT, a gate insulating layer 311, a first light blocking layer 376a, a color conversion layer 195, a passivation layer 320, a first insulating layer 356a, a polarization pattern 700, a pixel electrode PE, a second light blocking layer 376b, a first alignment layer 344a, a lower substrate (hereinafter, a second substrate) 302, a common electrode 330, a second alignment layer 344b, a polarization plate 381, and a liquid crystal layer 333.

In a case in which a surface of the first substrate 301 and a surface of the second substrate 302 that face each other are defined as upper surfaces of the corresponding substrates, respectively, and surfaces opposite to the upper surfaces are defined as lower surfaces of the corresponding substrates, respectively, the aforementioned polarization plate 381 may be disposed on the lower surface of the second substrate 302. A transmission axis of the polarization pattern 700 is perpendicular to a transmission axis of the polarization plate 381, and one of the transmission axes thereof is oriented parallel to the data line DL.

The polarization plate 381 polarizes a light L emitted from the backlight unit 444. The polarization plate 381 is disposed between the backlight unit 444 and the second substrate 302.

The second substrate 302 is disposed between the first substrate 301 and the backlight unit 444.

The pixel PX is connected to a gate line GL and a data line DL. For example, the pixel PX is connected to the gate line GL and the data line DL through the switching element TFT.

The switching element TFT includes a semiconductor layer 321, a gate electrode GE, a source electrode SE, and a drain electrode DE. The gate electrode GE is connected to the gate line GL, the source electrode SE is connected to the data line DL, and the drain electrode DE is connected to the polarization pattern 700.

The switching element TFT may be a thin film transistor (“TFT”).

The gate electrode GE and the gate line GL are disposed on the first substrate 301.

The gate electrode GE may have a shape protruding toward the pixel electrode PE from the gate line GL. The gate electrode GE and the gate line GL may be unitary.

The gate electrode GE may include or be formed of aluminum (Al) or alloys thereof, silver (Ag) or alloys thereof, copper (Cu) or alloys thereof, and/or molybdenum (Mo) or alloys thereof. In an alternative exemplary embodiment, the gate electrode GE may include or be formed of one of chromium (Cr), tantalum (Ta), and titanium (Ti). In an exemplary embodiment, the gate electrode GE may have a multilayer structure including at least two conductive layers that have different physical properties from one another.

Although not illustrated, an end portion of the gate line GL may be connected to another layer or an external driving circuit. The end portion of the gate line GL may have a larger planar area than a planar area of another portion of the gate line GL. The gate line GL may include substantially a same material and may have substantially a same structure (e.g., a multilayer structure) as those of the gate electrode GE. The gate line GL and the gate electrode GE may be simultaneously provided in substantially a same process.

As illustrated in FIG. 2, the gate insulating layer 311 is disposed on the first substrate 301, the gate electrode GE, and the gate line GL. In such an exemplary embodiment, the gate insulating layer 311 may be disposed over an entire surface of the first substrate 301 including the gate electrode GE and the gate line GL.

The gate insulating layer 311 may include or be formed of silicon nitride (SiNx) or silicon oxide (SiOx). The gate insulating layer 311 may have a multilayer structure including at least two insulating layers having different physical properties.

As illustrated in FIG. 2, the semiconductor layer 321 is disposed on the gate insulating layer 311. As illustrated in FIGS. 1 and 2, the semiconductor layer 321 overlaps at least a portion of the gate electrode GE.

The semiconductor layer 321 may include amorphous silicon, polycrystalline silicon, or the like. In addition, the semiconductor layer 321 may include or be formed of one of polycrystalline silicon and/or an oxide semiconductor such as indium gallium zinc oxide (IGZO) or indium zinc tin oxide (IZTO).

The source electrode SE is disposed on the gate insulating layer 311 and the semiconductor layer 321. The source electrode SE overlaps the semiconductor layer 321 and the gate electrode GE. The source electrode SE may have a shape protruding from the data line DL toward the gate electrode GE. The source electrode SE and the data line DL may be unitary. Although not illustrated, the source electrode SE may be a portion of the data line DL.

The source electrode SE may include or be formed of a refractory metal, such as molybdenum, chromium, tantalum, titanium, and/or an alloy thereof. The source electrode SE may have a multilayer structure including a refractory metal layer and a low-resistance conductive layer. Examples of the multilayer structure may include: a double-layer structure including a chromium or molybdenum (alloy) lower layer and an aluminum (alloy) upper layer; and a triple-layer structure including a molybdenum (alloy) lower layer, an aluminum (alloy) intermediate layer, and a molybdenum (alloy) upper layer. In an alternative exemplary embodiment, the source electrode SE may include or be formed of any suitable metals and/or conductors rather than the aforementioned materials.

As illustrated in FIG. 2, the data line DL is disposed on the gate insulating layer 311. Although not illustrated, an end portion of the data line DL may be connected to another layer or an external driving circuit. The end portion of the data line DL may have a larger planar area than a planar area of another portion of the data line DL. The data line DL may include substantially a same material and may have substantially a same structure (e.g., a multilayer structure) as those of the source electrode SE. The data line DL and the source electrode SE may be simultaneously provided in substantially a same process.

The data line DL intersects the gate line GL. A portion of the data line DL intersecting the gate line GL may have a smaller line width than a line width of another portion of the data line DL, and a portion of the gate line GL intersecting the data line DL may have a smaller line width than a line width of another portion of the gate line GL. Accordingly, a parasitic capacitance between the data line DL and the gate line GL may be reduced.

The drain electrode DE is disposed on the gate insulating layer 311 and the semiconductor layer 321 and spaced apart from the source electrode SE at a predetermined distance. The drain electrode DE overlaps the semiconductor layer 321 and the gate electrode GE. A channel area of the switching element TFT is positioned between the drain electrode DE and the source electrode SE.

The drain electrode DE is connected to the polarization pattern 700. The drain electrode DE is connected to the pixel electrode PE through the polarization pattern 700. In such an exemplary embodiment, the drain electrode DE and the polarization pattern 700 are electrically connected to each other through a contact hole 950.

The drain electrode DE may include substantially a same material and may have substantially a same structure (e.g., a multilayer structure) as those of the source electrode SE. The drain electrode DE and the source electrode SE may be simultaneously provided in substantially a same process.

The switching element TFT may further include a first ohmic contact layer 321a and a second ohmic contact layer 321b.

The first ohmic contact layer 321a is disposed between the semiconductor layer 321 and the source electrode SE. The first ohmic contact layer 321a reduces an interfacial resistance between the semiconductor layer 321 and the source electrode SE.

The first ohmic contact layer 321a may include silicide or n+ hydrogenated amorphous silicon doped with n-type impurity ions, e.g., phosphorus (P) or phosphine (PH₃), at high concentration.

The second ohmic contact layer 321b is disposed between the semiconductor layer 321 and the drain electrode DE. The second ohmic contact layer 321b reduces an interfacial resistance between the semiconductor layer 321 and the drain electrode DE. The second ohmic contact layer 321b may include substantially a same material and may have substantially a same structure (e.g., a multilayer structure) as those of the aforementioned first ohmic contact layer 321a. The second ohmic contact layer 321b and the first ohmic contact layer 321a may be simultaneously provided in substantially a same process.

Although not illustrated, the semiconductor layer 321 may further be disposed between the gate insulating layer 311 and the source electrode SE. In addition, the semiconductor layer 321 may further be disposed between the gate insulating layer 311 and the drain electrode DE. In such an exemplary embodiment, the semiconductor layer between the gate insulating layer 311 and the source electrode SE is defined as a first additional semiconductor layer, and the semiconductor layer between the gate insulating layer 311 and the drain electrode DE is defined as a second additional semiconductor layer. In such an exemplary embodiment, the aforementioned first ohmic contact layer 321a may further be disposed between the first additional semiconductor layer and the source electrode SE, and the aforementioned second ohmic contact layer 321b may further be disposed between the second additional semiconductor layer and the drain electrode DE.

In addition, although not illustrated, the semiconductor layer 321 may further be disposed between the gate insulating layer 311 and the data line DL. In such an exemplary embodiment, the semiconductor layer between the gate insulating layer 311 and the data line DL is defined as a third additional semiconductor layer. In such an exemplary embodiment, the aforementioned first ohmic contact layer 321a may further be disposed between the third additional semiconductor layer and the data line DL.

The color conversion layer 195 is disposed on the gate insulating layer 311. An edge portion of the color conversion layer 195 may be disposed on the gate line GL and the data line DL.

The color conversion layer 195 converts a color of the light L emitted from the backlight unit 444. To this end, the color conversion layer 195 converts a wavelength of the light L emitted from the backlight unit 444. For example, the color conversion layer 195 may include quantum dot particles. In addition, the color conversion layer 195 may further include at least one of (or any combination of): a sulfide-based metal, a silicon (Si)-based metal, and a nitride-based metal.

The quantum dot particle converts wavelength of light to emit a desired light. Based on the size of the quantum dot particle, wavelength of light emitted from the color conversion layer 195 may vary. In other words, based on a diameter of the quantum dot, color of light emitted from the color conversion layer 195 may vary.

The quantum dot particle may have a diameter in a range of about 2 nanometers (nm) to about 10 nm. In general, in a case in which the quantum dot particle has a relatively small diameter, a wavelength of an emitted light may decrease to generate a blue-based light. Further, as the size of the quantum dot increases, the wavelength of the emitted light increases to emit a red-based light. For example, a quantum dot particle having a diameter of about 10 nm may emit red light, a quantum dot particle having a diameter of about 7 nm may emit green light, and a quantum dot particle having a diameter of about 5 nm may emit blue light.

The quantum dot particle may have a double structure including an inner core and an outer shell surrounding the inner core. For example, the quantum dot particle including CdSe/ZnS includes an inner core including CdSe and an outer shell including ZnS.

In an alternative exemplary embodiment, the color conversion layer 195 may include a quantum rod particle, in lieu of the quantum dot particle.

The plurality of pixels PX may include a red pixel, a green pixel, and a blue pixel. In such an exemplary embodiment, a color conversion layer of the red pixel converts white light provided from the backlight unit 444 into red light, a color conversion layer of the green pixel converts white light provided from the backlight unit 444 into green light, and a color conversion layer of the blue pixel converts white light provided from the backlight unit 444 into blue light.

In an exemplary embodiment, in a case in which blue light is emitted from the backlight unit 444, the blue pixel may include a light transmission layer, in lieu of the color conversion layer. The light transmission layer transmits the blue light provided from the backlight unit 444 intact without substantially changing the color (or wavelength) of the transmitted light. The light transmission layer may include a transparent photoresist, for example. In an exemplary embodiment, the light transmission layer may further include a light scattering agent. The light scattering agent may use titanium dioxide (TiO₂).

As described hereinabove, when blue light is emitted from the backlight unit 444, the color conversion layer of the red pixel may convert the blue light into red light, and the color conversion layer of the green pixel may convert the blue light into green light.

From a plane, the first light blocking layer 376a is disposed among adjacent ones of the pixels PX. For example, the first light blocking layer 376a is disposed between a color conversion layer of one pixel (hereinafter, a first pixel) and a color conversion layer of another pixel (hereinafter, a second pixel) that is adjacent to the first pixel. Vertically, the first light blocking layer 376a is disposed on the gate insulating layer 311 and the data line DL. Although not illustrated, the first light blocking layer 376a may further be disposed on the switching element TFT. The first light blocking layer 376a prevents light transmitted through the color conversion layer of the first pixel from being incident to the color conversion layer of the second pixel.

As illustrated in FIG. 2, the passivation layer 320 is disposed on the data line DL, the source electrode SE, the drain electrode DE, the channel area of the semiconductor layer 321, the gate insulating layer 311, the color conversion layer 195, and the first light blocking layer 376a. In such an exemplary embodiment, the passivation layer 320 may be disposed over an entire surface of the first substrate 301 including the data line DL, the source electrode SE, the drain electrode DE, the channel area of the semiconductor layer 321, the gate insulating layer 311, the color conversion layer 195, and the first light blocking layer 376a. The passivation layer 320 is defined with a hole (hereinafter, a first hole) on the drain electrode DE.

The passivation layer 320 may include an inorganic insulating material such as silicon nitride (SiNₓ) or silicon oxide (SiOₓ), and in such an exemplary embodiment, an inorganic insulating material having photosensitivity and having a dielectric constant of about 4.0 may be used. In an alternative exemplary embodiment, the passivation layer 320 may have a double-layer structure including a lower inorganic layer and an upper organic layer, which is found to impart excellent insulating characteristics and does not damage an exposed portion of the semiconductor layer 321. The passivation layer 320 may have a thickness greater than or equal to about 5000 Å, e.g., in a range of about 6000 Å to about 8000 Å.

As illustrated in FIG. 2, the first insulating layer 356a is disposed on the passivation layer 320. The first insulating layer 356a is defined with a hole (hereinafter, a second hole) above the first hole. The second hole may be larger than the first hole. For example, a diameter of the second hole may be greater than a diameter of the first hole.

The first insulating layer 356a may include an organic layer having a relatively low dielectric constant. For example, the first insulating layer 356a may include a photosensitive organic material having a dielectric constant lower than that of the passivation layer 320.

The polarization pattern 700 polarizes light emitted from the backlight unit 444 and transmitted through the polarization plate 381 and the liquid crystal layer 333. As illustrated in FIG. 2, the polarization pattern 700 is disposed on the first insulating layer 356a. The polarization pattern 700 is connected to the switching element TFT through the contact hole 950. For example, the polarization pattern 700 is connected to the drain electrode DE of the switching element TFT through the contact hole 950.

The contact hole 950 includes the first hole of the passivation layer 320 and the second hole of the first insulating layer 356a. A portion of the drain electrode DE is exposed through the contact hole 950. In such an exemplary embodiment, the first and second holes of the contact hole 950 have a larger size as positioned more upwardly, and accordingly, each of the polarization pattern 700 and the pixel electrode PE at an inner wall of the contact hole 950 may include a plurality of curved portions. Accordingly, the polarization pattern 700 and the pixel electrode PE may not be damaged in the contact hole 950, which has a large depth. For example, the polarization pattern 700 and the pixel electrode PE may be prevented from being cut.

The polarization pattern 700 may be transferred to the first insulating layer 356a using a method of stamping or imprinting. The polarization pattern 700 may be a wire grid polarizer. The polarization pattern 700 may include a metal material such as aluminum.

As illustrated in FIG. 1, the polarization pattern 700 may include a plurality of polarization lines 750. Each of the polarization lines 750 is substantially parallel to the data line DL. In addition, the polarization lines 750 are each parallel to one another.

The polarization lines 750 are each spaced apart from one another. A gap (hereinafter, a first gap) between two adjacent ones of the polarization lines 750 may be substantially the same as a gap (hereinafter, a second gap) between another two adjacent ones of the polarization lines 750. In an alternative exemplary embodiment, the first gap may differ from the second gap. In addition, a gap (hereinafter, a third gap) between one of the polarization lines 750 and another of the polarization lines 750 adjacent to the left side of the one of the polarization lines 750 may be substantially the same as a gap (hereinafter, a fourth gap) between the one of the polarization lines 750 and another of the polarization lines 750 adjacent to the right side of the one of the polarization lines 750. In an alternative exemplary embodiment, the third gap may differ from the fourth gap. A gap among adjacent ones of the polarization lines 750 may be greater than 0 and less than about 40 nm, for example.

At least one of the plurality of polarization lines 750 may be connected to the switching element TFT. For example, as illustrated in FIG. 1, one of the polarization lines 750 overlapping the drain electrode DE may be connected to the drain electrode DE.

In an exemplary embodiment, although not illustrated, the polarization pattern 700 may overlap a previous gate line GL′. For example, at least one of the plurality of polarization lines 750 of the polarization pattern 700 may overlap the previous gate line GL′. In a single frame period, the previous gate line GL′ may be driven before the gate line GL is driven.

As illustrated in FIGS. 1 and 2, the pixel electrode PE is disposed on the polarization pattern 700 and the first insulating layer 356a. The pixel electrode PE may overlap the entirety of the polarization pattern 700. In other words, the entirety of the polarization pattern 700 may overlap the pixel electrode PE. For example, the pixel electrode PE may overlap the plurality of polarization lines 750. In addition, the pixel electrode PE may contact the plurality of polarization lines 750.

The polarization pattern 700 is disposed between the first insulating layer 356a and the pixel electrode PE.

The pixel electrode PE and the polarization pattern 700 are connected to each other in a light emission area 111. In other words, the pixel electrode PE may contact the polarization pattern 700 in the light emission area 111. For example, an upper surface of the polarization pattern 700 that is opposite to an interfacial surface between the polarization pattern 700 and the first insulating layer 356a may contact the pixel electrode PE. For example, when a surface of the polarization pattern 700 contacting the first insulating layer 356a is defined as a first surface of the polarization pattern 700, and a surface of the polarization pattern 700 opposite to the first surface is defined as a second surface (i.e., an upper surface of the polarization pattern 700) of the polarization pattern 700, the second surface contacts the pixel electrode PE.

The entirety of the second surface of the polarization pattern 700 may contact the pixel electrode PE. In an alternative exemplary embodiment, a portion of the second surface of the polarization pattern 700 may contact the pixel electrode PE. Herein, a portion of the second surface contacting the pixel electrode PE is defined as a contacting surface of the polarization pattern 700, and a portion of the second surface not contacting the pixel electrode PE is defined as a non-contacting surface of the polarization pattern 700. In such an exemplary embodiment, the contacting surface of the polarization pattern 700 may have a larger area than an area of the non-contacting surface of the polarization pattern 700.

A contacting area between the polarization pattern 700 and the pixel electrode PE is larger than a contacting area between the polarization pattern 700 and the switching element TFT. In other words, the contacting area (hereinafter, a first contacting area) between the polarization pattern 700 and the pixel electrode PE is larger than the contacting area (hereinafter, a second contacting area) between the polarization pattern 700 and the drain electrode DE. For example, the first contacting area is at least two times the second contacting area.

A hole 999 may be defined among adjacent ones of the polarization lines 750. For example, the hole 999 may be an area defined by being surrounded by adjacent ones of the polarization lines 750, the first insulating layer 356a, and the pixel electrode PE. The hole 999 may be filled with air.

As illustrated in FIG. 1, the pixel electrode PE may overlap the previous gate line GL′. A storage capacitor may be formed between the pixel electrode PE and the previous gate line GL′.

The pixel electrode PE may include a transparent conductive material, e.g., indium tin oxide (ITO) or indium zinc oxide (IZO). In such an exemplary embodiment, for example, ITO may include a polycrystalline material or a monocrystalline material, and IZO may include a polycrystalline material or a monocrystalline material. Alternatively, IZO may include an amorphous material.

The second light blocking layer 376b defines a light emission area 111 of the pixel PX. The second light blocking layer 376b is disposed in an area (hereinafter, a light blocking area) except the light emission area 111. For example, as illustrated in FIG. 2, the second light blocking layer 376b is disposed on the first insulating layer 356a and the pixel electrode PE, corresponding to the light blocking area. The second light blocking layer 376b may include substantially a same material as a material included in the first light blocking layer 376a.

In an exemplary embodiment, as illustrated in FIG. 2, the polarization pattern and 700 the pixel electrode PE may further be connected to each other in the light blocking area.

As illustrated in FIG. 2, a column spacer 472 is disposed on the second light blocking layer 376b. For example, the column spacer 472 may be disposed on the second light blocking layer 376b to overlap the switching element TFT. The column spacer 472 and the second light blocking layer 376b may be unitary. The column spacer 472 and the second light blocking layer 376b may be simultaneously provided in substantially a same process.

As illustrated in FIG. 2, the first alignment layer 344a is disposed on the second light blocking layer 376b, the column spacer 472, and the pixel electrode PE. The first alignment layer 344a may be a rubbed alignment layer or an unrubbed alignment layer.

The common electrode 330 is disposed on the second substrate 302. The common electrode 330 may be disposed over an entire surface of the second substrate 302. The common electrode 330 and the pixel electrode PE may include or be formed of substantially a same material. In an exemplary embodiment, when the pixel electrode PE includes IZO, the common electrode 330 may include ITO.

The second alignment layer 344b is disposed on the common electrode 330. The second alignment layer 344b may be a rubbed alignment layer or an unrubbed alignment layer.

The liquid crystal layer 333 is disposed between the first substrate 301 and the second substrate 302. For example, the liquid crystal layer 333 may be disposed between the first alignment layer 344a of the first substrate 301 and the second alignment layer 344b of the second substrate 302.

The polarization plate 381 polarizes the light L emitted from the backlight unit 444. The polarization plate 381 is disposed between the backlight unit 444 and the second substrate 302.

The liquid crystal layer 333 may include vertically-aligned twisted-nematic (VA-TA) liquid crystals and chiral dopants.

In a case in which the LCD device includes a backlight unit 444 that emits white light, a multiplication (Δnd) of a cell gap (d) of the LCD device by a dielectric anisotropy (Δn) of the liquid crystal layer 333 may be in a range of about 270 nm to about 450 nm. The cell gap d of the LCD device may be, for example, a cell gap between the first substrate 301 and the second substrate 302. In addition, in a case in which the LCD device includes a backlight unit 444 that emits white light, the aforementioned multiplication Δnd may be about 315 nm or less. In an alternative exemplary embodiment, in a case in which the LCD device includes a backlight unit 444 that emits blue light, the aforementioned multiplication Δnd may be in a range of about 205 nm to about 300 nm.

In a case in which the LCD device includes a backlight unit 444 that emits white light, a ratio (d/p) of the cell gap d to a pitch (p) of the liquid crystal layer 333 may be in a range of about 0.20 to about 0.35. That is, the ratio d/p may be in a range of about 0.20 to about 0.35. In such an exemplary embodiment, the pitch p is a pitch reflecting an effect due to the chiral dopant, and may be about 12 micrometers (μm). In an alternative exemplary embodiment, in a case in which the LCD device includes a backlight unit 444 that emits blue light, the ratio d/p may be in a range of about 0.1 to about 0.5.

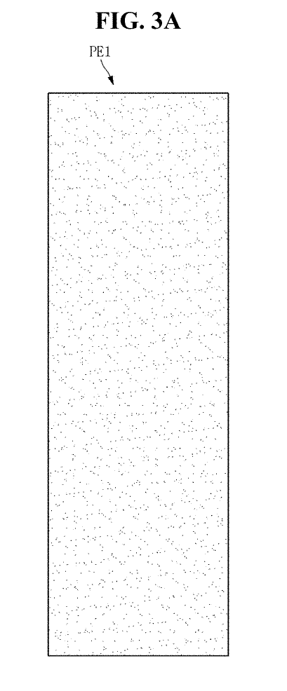

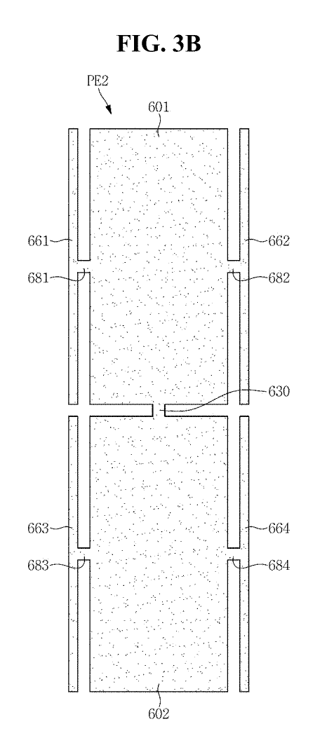

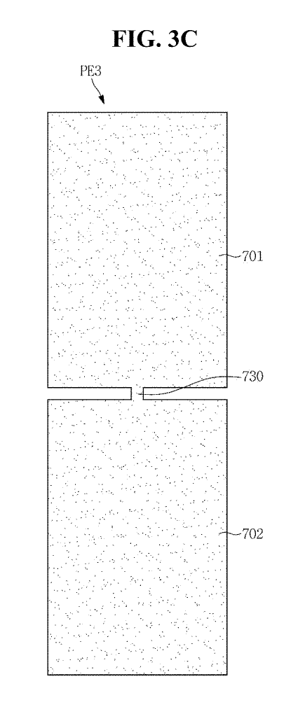

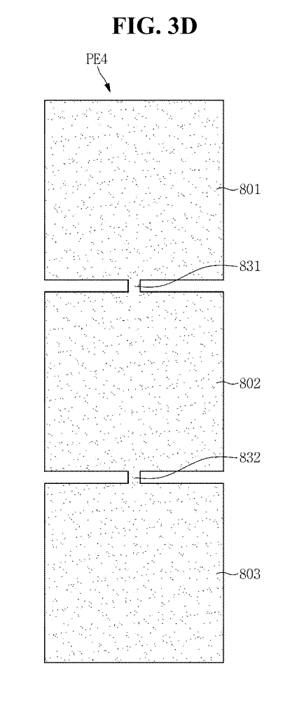

FIGS. 3A, 3B, 3C, and 3D are views illustrating various shapes of a pixel electrode.

A pixel electrode PE1 illustrated in FIG. 3A may include a single planar electrode having a quadrangular shape. In such an exemplary embodiment, the pixel electrode PE1 illustrated in FIG. 3A may overlap a switching element TFT.

A pixel electrode PE2 illustrated in FIG. 3B may include a first planar electrode 601, a second planar electrode 602, a first auxiliary electrode 661, a second auxiliary electrode 662, a third auxiliary electrode 663, a fourth auxiliary electrode 664, a main connecting electrode 630, a first auxiliary connecting electrode 681, a second auxiliary connecting electrode 682, a third auxiliary connecting electrode 683, and a fourth auxiliary connecting electrode 684.

The first planar electrode 601, the second planar electrode 602, the first auxiliary electrode 661, the second auxiliary electrode 662, the third auxiliary electrode 663, the fourth auxiliary electrode 664, the main connecting electrode 630, the first auxiliary connecting electrode 681, the second auxiliary connecting electrode 682, the third auxiliary connecting electrode 683, and the fourth auxiliary connecting electrode 684 are unitary.

Each of the first planar electrode 601 and the second planar electrode 602 may have a quadrangular shape. The first planar electrode 601 and the second planar electrode 602 may have substantially an equal area.

The first planar electrode 601 is disposed between the first auxiliary electrode 661 and the second auxiliary electrode 662, and the second planar electrode 602 is disposed between the third auxiliary electrode 663 and the fourth auxiliary electrode 664.

The main connecting electrode 630 is disposed between the first planar electrode 601 and the second planar electrode 602. The main connecting electrode 630 is connected to the first planar electrode 601 and the second planar electrode 602. The main connecting electrode 630 has a smaller area than an area of the first planar electrode 601 (or the second planar electrode 602).

The first auxiliary connecting electrode 681 is disposed between the first auxiliary electrode 661 and the first planar electrode 601. The first auxiliary connecting electrode 681 is connected to the first auxiliary electrode 661 and the first planar electrode 601. The first auxiliary connecting electrode 681 may have a smaller area than an area of the first planar electrode 601, and may have substantially a same length as a length of the first planar electrode 601.

The second auxiliary connecting electrode 682 is disposed between the second auxiliary electrode 662 and the first planar electrode 601. The second auxiliary connecting electrode 682 is connected to the second auxiliary electrode 662 and the first planar electrode 601. The second auxiliary connecting electrode 682 may have a smaller area than an area of the first planar electrode 601, and may have substantially a same length as a length of the first planar electrode 601.

The first, second, third, and fourth auxiliary electrodes 661, 662, 663, and 664 may each have substantially a same area.

The first, second, third, and fourth auxiliary connecting electrodes 681, 682, 683, and 684 may each have substantially a same area.

A pixel electrode PE3 illustrated in FIG. 3C may include a first planar electrode 701, a second planar electrode 702, and a main connecting electrode 730.

The first planar electrode 701, the second planar electrode 702, and the main connecting electrode 730 are unitary.

Each of the first planar electrode 701 and the second planar electrode 702 may have a quadrangular shape. The first planar electrode 701 and the second planar electrode 702 may have substantially a same area.

The main connecting electrode 730 is disposed between the first planar electrode 701 and the second planar electrode 702. The main connecting electrode 730 is connected to the first planar electrode 701 and the second planar electrode 702. The main connecting electrode 730 has a smaller area than an area of the first planar electrode 701 (or the second planar electrode 702).

A pixel electrode PE4 illustrated in FIG. 3D may include a first planar electrode 801, a second planar electrode 802, a third planar electrode 803, a first main connecting electrode 831, and a second main connecting electrode 832.

The first planar electrode 801, the second planar electrode 802, the third planar electrode 803, the first main connecting electrode 831, and the second main connecting electrode 832 are unitary.

Each of the first planar electrode 801, the second planar electrode 802, and the third planar electrode 803 may have a quadrangular shape. Each of the first, second, and third planar electrodes 801, 802, and 803 may have substantially a same area.

The first main connecting electrode 831 is disposed between the first planar electrode 801 and the second planar electrode 802. The first main connecting electrode 831 is connected to the first planar electrode 801 and the second planar electrode 802. The first main connecting electrode 831 has a smaller area than an area of the planar electrode (i.e., one of the first, second, and third planar electrodes 801, 802, and 803).

The second main connecting electrode 832 is disposed between the second planar electrode 802 and the third planar electrode 803. The second main connecting electrode 832 is connected to the second planar electrode 802 and the third planar electrode 803. The second main connecting electrode 832 has a smaller area than an area of the planar electrode (i.e., one of the first, second, and third planar electrodes 801, 802, and 803).

The pixel electrode PE illustrated in FIG. 1 may have substantially a same shape as a shape of one of the pixel electrodes PE1, PE2, PE3, and PE4 respectively illustrated in FIGS. 3A, 3B, 3C, and 3D.

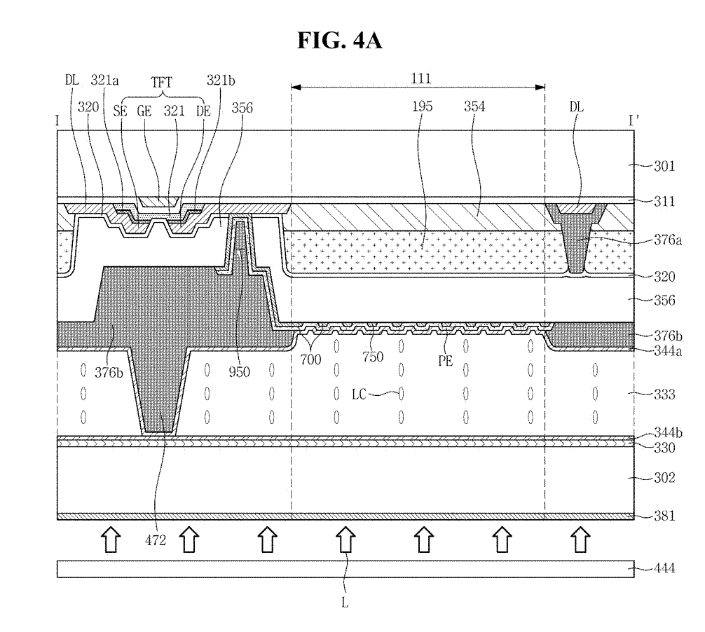

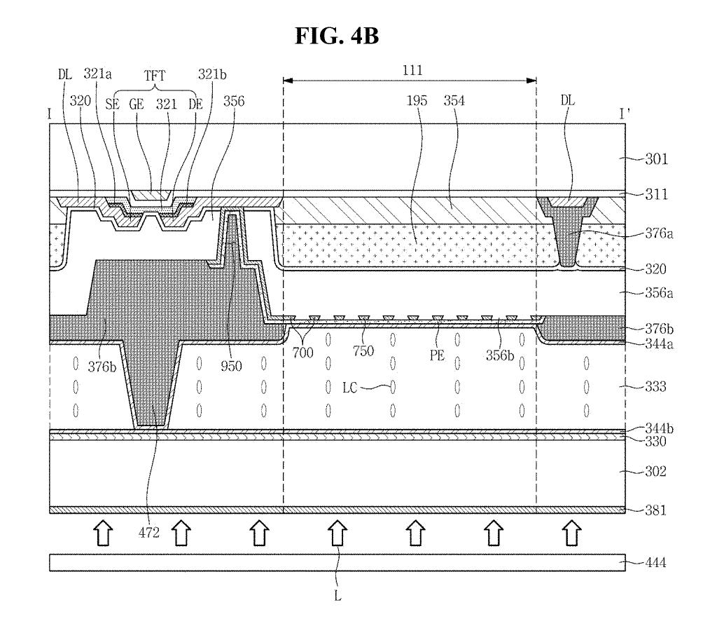

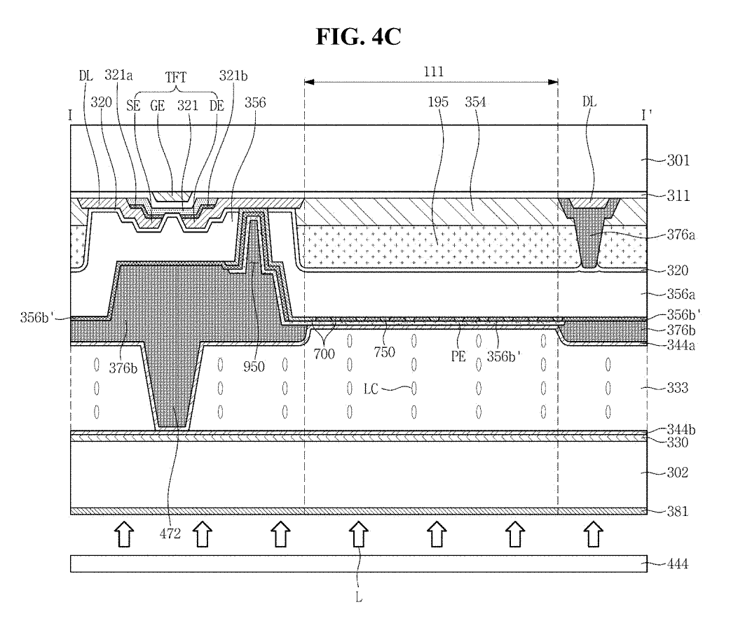

FIG. 4A is a cross-sectional view illustrating an alternative exemplary embodiment taken along line I-I′ of FIG. 1, FIG. 4B is a cross-sectional view illustrating another alternative exemplary embodiment taken along line I-I′ of FIG. 1, and FIG. 4C is a cross-sectional view illustrating still another alternative exemplary embodiment taken along line I-I′ of FIG. 1.

As illustrated in FIG. 4A, an exemplary embodiment of an LCD device may further include a color filter 354. For example, a pixel PX may further include the color filter 354.

The color filter 354 is disposed between a gate insulating layer 311 and a color conversion layer 195. The color filter 354 and the color conversion layer 195 may be manufactured in substantially a same mask process. Accordingly, from a plane, the color filter 354 and the color conversion layer 195 may have substantially a same shape.

The color filter 354 may be classified into a red color filter, a green color filter, and a blue color filter. The red color filter is disposed between a color conversion layer of a red pixel and the gate insulating layer 311, the green color filter is disposed between a color conversion layer of a green pixel and the gate insulating layer 311, and the blue color filter is disposed between a color conversion layer of a blue pixel and the gate insulating layer 311. In an exemplary embodiment, in a case in which the backlight unit 444 generates blue light, the blue color filter may be omitted. That is, the blue color filter may be substituted with the aforementioned light transmission layer.

In addition, as illustrated in FIG. 4B, an exemplary embodiment of an LCD device may further include a second insulating layer 356b. The second insulating layer 356b is disposed among adjacent ones of polarization lines. For example, the second insulating layer 356b may be disposed in the aforementioned hole 999. The second insulating layer 356b may include substantially a same material as a material included in the first insulating layer 356a. In an exemplary embodiment, as illustrated in FIG. 4B, the second insulating layer 356b and the first insulating layer 356a may be unitary.

In an exemplary embodiment, an exemplary embodiment of an LCD device may further include a second insulating layer 356b′ which has a shape illustrated in FIG. 4C. The second insulating layer 356b′ is disposed between a pixel electrode PE and the first insulating layer 356a. In addition, the second insulating layer 356b′ is disposed in the aforementioned hole 999. In addition, the second insulating layer 356b′ is disposed between a second light blocking layer 376b and the first insulating layer 356a. Due to the second insulating layer 356b′, the pixel electrode PE and a polarization pattern 700 may not be connected to each other in a contact hole 950. The pixel electrode PE and the polarization pattern 700 are connected to each other in a light emission area 111.

Configurations illustrated in FIGS. 4A, 4B, and 4C are substantially the same as those illustrated in FIGS. 1 and 2, and thus, descriptions pertaining to the configurations illustrated in FIGS. 4A, 4B, and 4C will make reference to descriptions pertaining to the configurations illustrated in FIGS. 1 and 2.

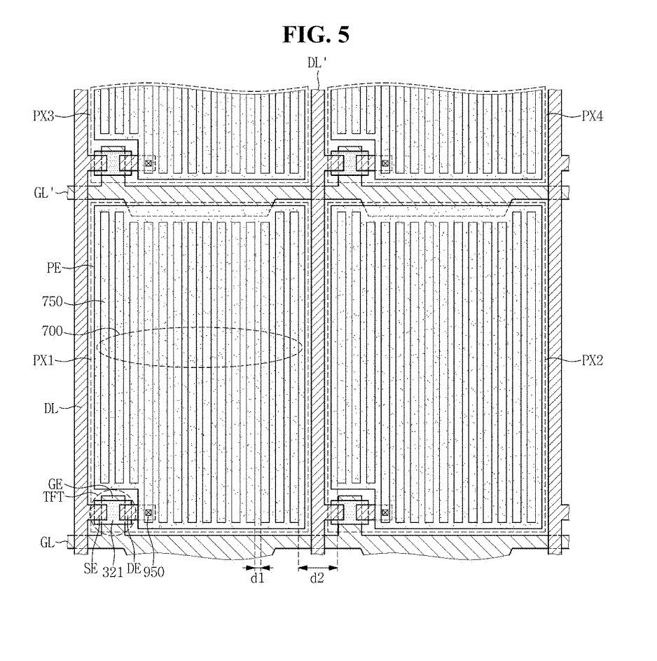

FIG. 5 is a plan view illustrating an exemplary embodiment of a plurality of pixels.

FIG. 5 illustrates four adjacent pixels PX1, PX2, PX3, and PX4. Each of first, second, third and fourth pixels PX1, PX2, PX3, and PX4 may have substantially the same configurations as those of the pixel PX illustrated in FIG. 1. In an exemplary embodiment, a portion of the third and fourth pixels PX3 and PX4 may not be illustrated in FIG. 5.

Respective polarization patterns 700 of the first, second, third and fourth pixels PX1, PX2, PX3, and PX4 are not connected to one another.

A distance among adjacent ones of polarization lines included in a single pixel is less than a distance among polarization lines respectively included in adjacent pixels. For example, when a distance between two adjacent ones of the polarization lines 750 included in the first pixel PX1 is defined as a distance d1 and a distance between a polarization line 750 of the first pixel PX1 and a polarization line 750 of the second pixel PX2 adjacent to the first pixel PX1 is defined as a distance d2, the distance d1 is less than the distance d2.

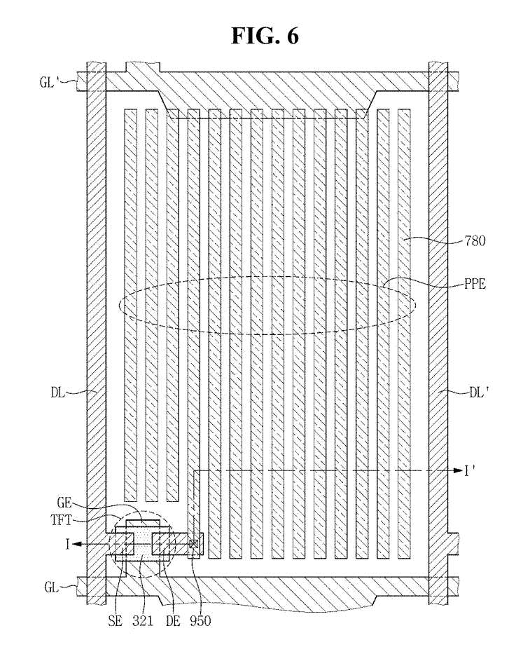

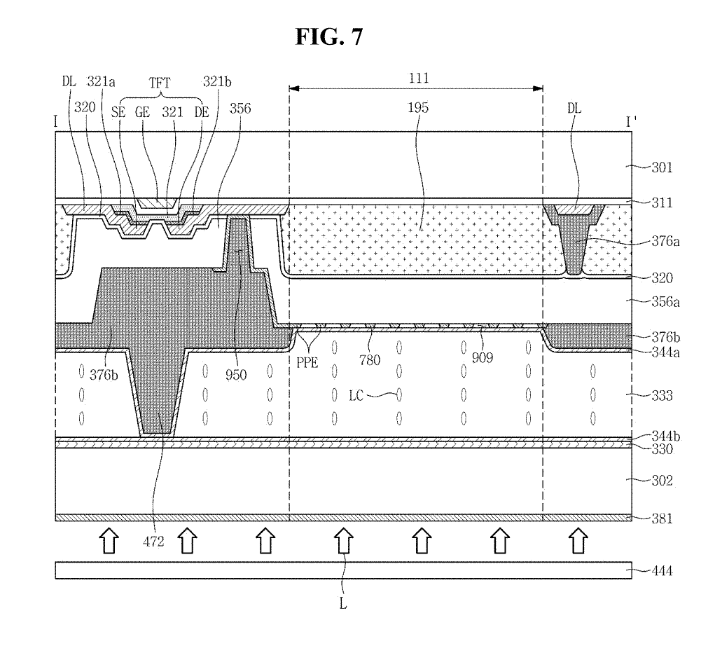

FIG. 6 is a plan view illustrating an alternative exemplary embodiment of an LCD device, and FIG. 7 is a cross-sectional view taken along line I-I′ of FIG. 6.

An alternative exemplary embodiment of an LCD device includes a plurality of pixels and a backlight unit.

As illustrated in FIGS. 6 and 7, a pixel PX includes a first substrate 301, a switching element TFT, a gate insulating layer 311, a first light blocking layer 376a, a color conversion layer 195, a passivation layer 320, a first insulating layer 356a, a polarization pixel electrode PPE, a second light blocking layer 376b, a first alignment layer 344a, a second substrate 302, a common electrode 330, a second alignment layer 344b, a polarization plate 381, and a liquid crystal layer 333.

The polarization pixel electrode PPE serves both roles of the aforementioned ones of the polarization pattern 700 and the pixel electrode PE. As illustrated in FIG. 7, the polarization pixel electrode PPE is disposed on the first insulating layer 356a. The polarization pixel electrode PPE is connected to the switching element TFT through a contact hole 950. For example, the polarization pixel electrode PPE is connected to a drain electrode DE of the switching element TFT through the contact hole 950.

As illustrated in FIG. 6, the polarization pixel electrode PE may include a plurality of polarization lines 780. Each of the polarization lines 780 is substantially parallel to the data line DL. In addition, the polarization lines 780 are each parallel to one another.

The polarization lines 780 are each spaced apart from one another. A gap (hereinafter, a first gap) between two adjacent ones of the polarization lines 750 may be substantially the same as a gap (hereinafter, a second gap) between another two adjacent ones of the polarization lines 780. In an alternative exemplary embodiment, the first gap may differ from the second gap. In addition, a gap (hereinafter, a third gap) between one of the polarization lines 780 and another of the polarization lines 780 adjacent to the left side of the one of the polarization lines 780 may be substantially the same as a gap (hereinafter, a fourth gap) between the one of the polarization lines 780 and another of the polarization lines 780 adjacent to the right side of the one of the polarization lines 780. In an alternative exemplary embodiment, the third gap may differ from the fourth gap. A gap between adjacent ones of the polarization lines 780 may be greater than 0 and less than about 40 nm, for example.

At least one of the plurality of polarization lines 780 may be connected to the switching element TFT. For example, as illustrated in FIG. 1, one of the polarization lines 780 overlapping the drain electrode DE may be connected to the drain electrode DE. In an exemplary embodiment, other polarization lines except the polarization line (hereinafter, a first polarization line) connected to the switching element TFT are not connected to any other conductor. For example, the aforementioned other polarization lines may maintain a floating state. The polarization lines 780 are spaced apart from one another at a significantly small gap in the nanometers, and thus a capacitor is formed among respective ones of the polarization lines 780. Due to a coupling phenomenon of the capacitor, a voltage of the first polarization line is induced to another polarization line (hereinafter, a second polarization line) that is adjacent to the first polarization line, and a voltage of the second polarization line may be induced to another polarization line that is adjacent to the second polarization line. Accordingly, although a voltage is applied to only one polarization line, substantially a same voltage may be applied to other polarization lines adjacent thereto.

The polarization pixel electrode PPE may overlap a previous gate line GL′. For example, at least one of the plurality of polarization lines 780 of the polarization pixel electrode PPE may overlap the previous gate line GL′.

The second light blocking layer 376b is disposed on the first insulating layer 356a and the polarization pixel electrode PPE, corresponding to a light blocking area.

As illustrated in FIG. 7, the first alignment layer 344a is disposed on the second light blocking layer 376a, the column spacer 472, and the polarization pixel electrode PPE. The first alignment layer 344a may have a concave portion and a convex portion. The first alignment layer 344a may be a rubbed alignment layer or an unrubbed alignment layer.

A hole 909 may be defined among adjacent ones of the polarization lines 780. For example, the hole 909 is an area defined by being surrounded by adjacent ones of the polarization lines 780, the first insulating layer 356a, and the first alignment layer 344a. The hole 909 may be filled with air.

In an exemplary embodiment, the first substrate 301, the switching element TFT, the gate insulating layer 311, the first light blocking layer 376a, the color conversion layer 195, the passivation layer 320, the first insulating layer 356a, the second substrate 302, the common electrode 330, the second alignment layer 344b, the polarization plate 381, and the liquid crystal layer 333 illustrated in FIG. 6 are substantially the same as those illustrated in FIGS. 1 and 2, and thus descriptions pertaining to configurations illustrated in FIG. 6 will make reference to descriptions pertaining to the configurations illustrated in FIGS. 1 and 2.

In addition, the LCD device illustrated in FIGS. 6 and 7 may further include the aforementioned color filter 354.

In addition, the LCD device illustrated in FIGS. 6 and 7 may further include a second insulating layer 356b disposed in the hole 909.

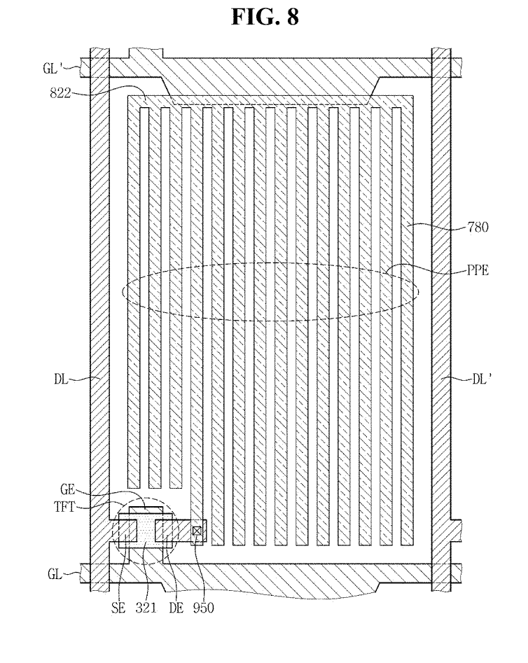

FIG. 8 is a plan view illustrating an alternative exemplary embodiment of a polarization pixel electrode.

As illustrated in FIG. 8, a polarization pixel electrode PPE may further include a connecting electrode 822. The connecting electrode 822 connects polarization lines 780 to one another. For example, as illustrated in FIG. 8, the connecting electrode 822 may connect respective end portions of the polarization lines 780 to one another. At least a portion of the connecting electrode 822 may overlap a previous gate line GL′.

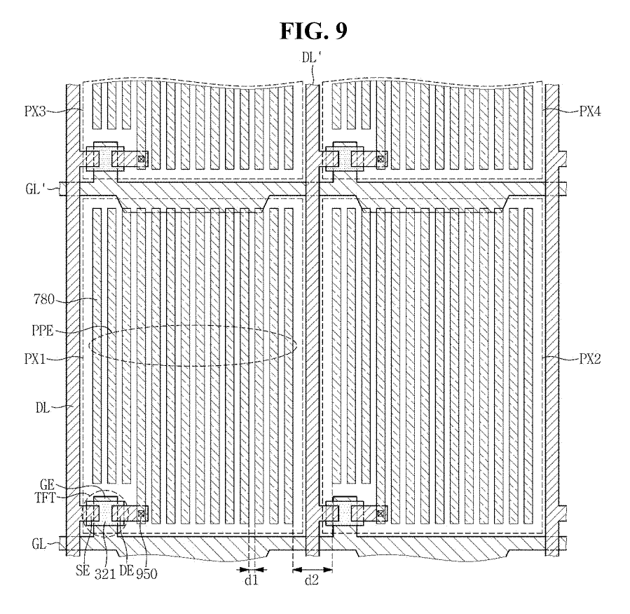

FIG. 9 is a plan view illustrating an alternative exemplary embodiment of a plurality of pixels.

FIG. 9 illustrates four adjacent pixels PX1, PX2, PX3, and PX4. Each of first, second, third and fourth pixels PX1, PX2, PX3, and PX4 may have substantially the same configurations as those of the pixel PX illustrated in FIG. 1. In an exemplary embodiment, a portion of the third and fourth pixels PX3 and PX4 may not be illustrated in FIG. 9.

Respective polarization pixel electrodes PPE of the first, second, third and fourth pixels PX1, PX2, PX3, and PX4 are not connected to one another.

A distance among adjacent ones of polarization lines 780 included in a single pixel is less than a distance among polarization lines 780 respectively included in adjacent pixels. For example, when a distance between two adjacent ones of the polarization lines 780 included in the first pixel PX1 is defined as a distance d1 and a distance between a polarization line 780 of the first pixel PX1 and a polarization line 780 of the second pixel PX2 adjacent to the first pixel PX1 is defined as a distance d2, the distance d1 is less than the distance d2.

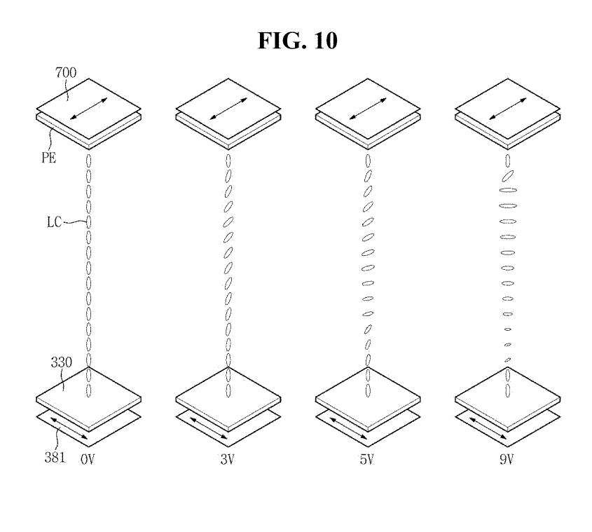

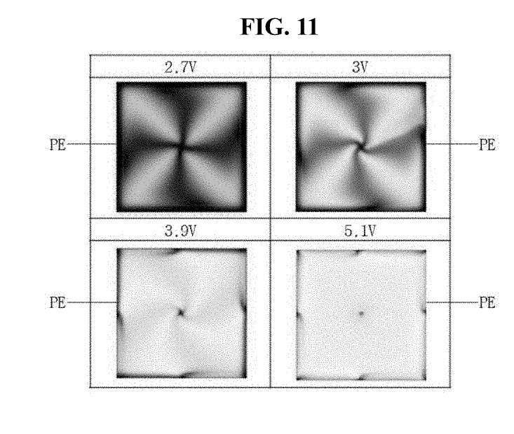

FIG. 10 is a view illustrating movement of liquid crystals based on a pixel voltage, and FIG. 11 is a view illustrating a light transmittance of a pixel electrode based on the pixel voltage.

As illustrated in FIG. 10, as a pixel voltage increases, a poloidal angle and an azimuth angle of liquid crystals LC may vary. For example, when the pixel voltage is about 0 V, a major axis of the liquid crystals LC is in a state of being perpendicular to a surface of a common electrode 330, and when the pixel voltage is about 9 V, a major axis of a great portion of the liquid crystals LC is in a state of being parallel to the surface of the common electrode 330.

As illustrated in FIG. 11, as the pixel voltage increases, a light transmittance of the pixel electrode PE increases. For example, when the pixel voltage is about 2.7 V, a light transmittance of the pixel electrode PE is relatively low, whereas, when the pixel voltage is about 5.1 V, the light transmittance of the pixel electrode PE is relatively high.

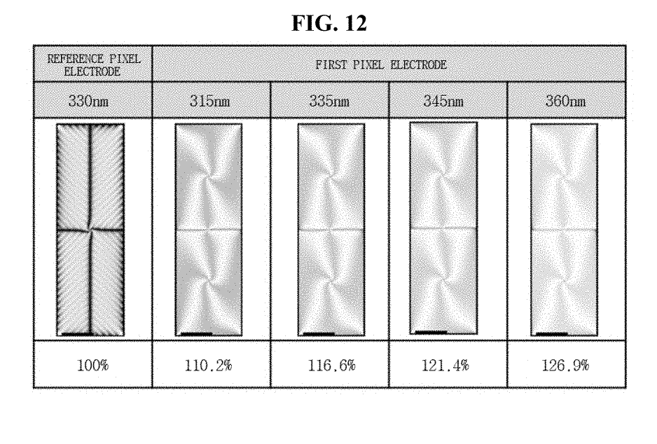

FIG. 12 is a view illustrating comparison between respective light transmittances of a reference pixel electrode and a first pixel electrode.

A reference pixel electrode includes four planar electrodes, and a light emission area is divided into four domains by each of the planar electrodes. When a multiplication Δnd is 330 nm, a light transmittance of the reference pixel electrode is to be defined as 100%.

The first pixel electrode is the pixel electrode illustrated in FIG. 3C. As the multiplication Δnd increases from about 315 nm to about 360 nm, the light transmittance of the first pixel electrode increases from about 110.2 percent (%) to about 126.9%.

Herein, the light transmittance refers to a light transmittance with respect to blue light.

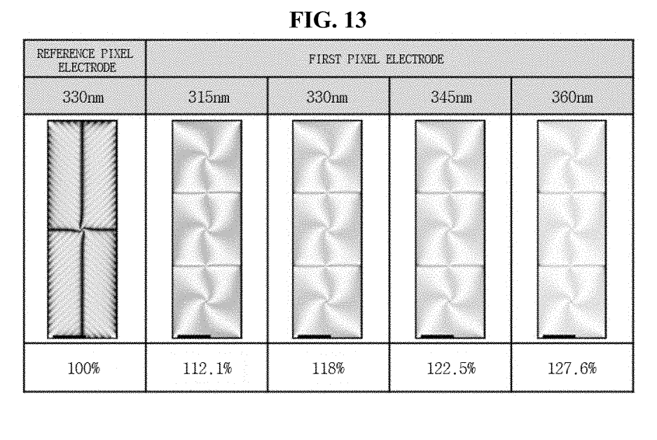

FIG. 13 is a view illustrating comparison between respective light transmittances of the reference pixel electrode and a second pixel electrode.

A reference pixel electrode includes four planar electrodes, and a light emission area is divided into four domains by each of the planar electrodes. When a multiplication Δnd is 330 nm, a light transmittance of the reference pixel electrode is to be defined as 100%.

The second pixel electrode is the pixel electrode illustrated in FIG. 3D. As the multiplication Δnd increases from about 315 nm to about 360 nm, the light transmittance of the second pixel electrode increases from about 112.1% to about 127.6%.

Herein, the light transmittance refers to a light transmittance with respect to blue light.

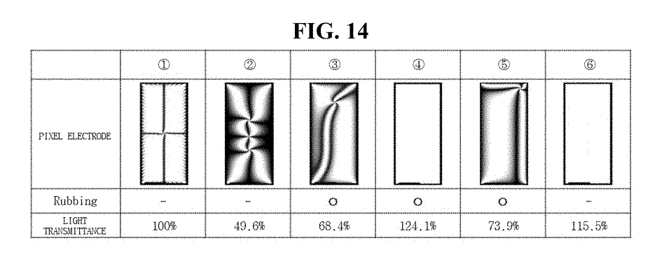

FIG. 14 is a view illustrating a light transmittance based on a shape of the pixel electrode and a rubbing process of an alignment layer.

A first LCD device \textcircled{1} includes a pixel electrode, a liquid crystal layer, a first alignment layer, and a second alignment layer. The liquid crystal layer of the first LCD device \textcircled{1} includes super vertically aligned (SVA) liquid crystals. The first and second alignment layers of the first LCD device \textcircled{1} are unrubbed alignment layers.

A second LCD device \textcircled{2} includes a pixel electrode, a liquid crystal layer, a first alignment layer, and a second alignment layer. The liquid crystal layer of the second LCD device \textcircled{2} includes vertically aligned (VA) liquid crystals. The first and second alignment layers of the second LCD device \textcircled{2} are unrubbed alignment layers.

A third LCD device \textcircled{3} includes a pixel electrode, a liquid crystal layer, a first alignment layer, and a second alignment layer. The liquid crystal layer of the third LCD device \textcircled{3} includes vertically aligned (VA) liquid crystals. The first and second alignment layers of the third LCD device \textcircled{3} are rubbed alignment layers.

A fourth LCD device \textcircled{4} includes a pixel electrode, a liquid crystal layer, a first alignment layer, and a second alignment layer. The liquid crystal layer of the fourth LCD device \textcircled{4} includes twisted nematic (TN) liquid crystals. The first and second alignment layers of the fourth LCD device \textcircled{4} are rubbed alignment layers. Multiplication Δnd of the fourth LCD device \textcircled{4} is about 533 nm.

A fifth LCD device \textcircled{5} includes a pixel electrode, a liquid crystal layer, a first alignment layer, and a second alignment layer. The liquid crystal layer of the fifth LCD device \textcircled{5} includes vertically-aligned twisted-nematic (VA-TA) liquid crystals. The first and second alignment layers of the fifth LCD device \textcircled{5} are rubbed alignment layers.

A sixth LCD device \textcircled{6} includes a pixel electrode, a liquid crystal layer, a first alignment layer, and a second alignment layer. The liquid crystal layer of the sixth LCD device \textcircled{6} includes the aforementioned chiral dopants and vertically-aligned twisted-nematic (VA-TA) liquid crystals. The first and second alignment layers of the sixth LCD device \textcircled{6} are unrubbed alignment layers. The multiplication Δnd of the six LCD device \textcircled{6} is about 500 nm.

When a light transmittance of the first LCD device \textcircled{1} is defined as 100%, the light transmittance of the fourth LCD device \textcircled{4} and the light transmittance of the sixth LCD device \textcircled{6} are higher than the light transmittance of the first LCD device \textcircled{1}.

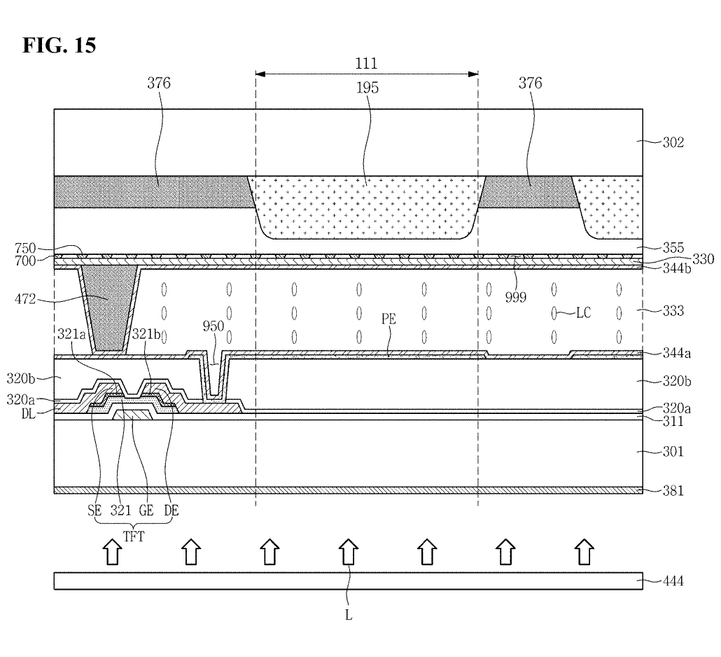

FIG. 15 is a cross-sectional view illustrating an alternative exemplary embodiment of an LCD device.

An exemplary embodiment of an LCD device includes a plurality of pixels PX and a backlight unit 444.

As illustrated in FIG. 15, a pixel PX includes a lower substrate (hereinafter, a first substrate) 301, a switching element TFT, a gate insulating layer 311, a first passivation layer 320a, a second passivation layer 320b, a pixel electrode PE, a first alignment layer 344a, a polarization plate 381, an upper substrate (hereinafter, a second substrate) 302, a light blocking layer 376, a color conversion layer 195, an insulating layer 355, a polarization pattern 700, a common electrode 330, a column spacer 472, a second alignment layer 344b, and a liquid crystal layer 333.

In a case in which a surface of the first substrate 301 and a surface of the second substrate 302 that face each other are defined as upper surfaces of the corresponding substrates, respectively, and surfaces opposite to the upper surfaces are defined as lower surfaces of the corresponding substrates, respectively, the aforementioned polarization plate 381 is disposed on the lower surface of the second substrate 302. A transmission axis of the polarization pattern 700 is perpendicular to a transmission axis of the polarization plate 381, and one of the transmission axes thereof is oriented parallel to the data line DL.

The polarization plate 381 polarizes a light L emitted from the backlight unit 444. The polarization plate 381 is disposed between the backlight unit 444 and the first substrate 301.

The first substrate 301 is disposed between the second substrate 302 and the backlight unit 444.

The switching element TFT and the pixel electrode PE are disposed on the first substrate 301. A drain electrode DE of the switching element TFT is connected to the pixel electrode PE through a contact hole 950.

The first passivation layer 320a is disposed on the switching element TFT and the gate insulating layer 311. The first passivation layer 320a is defined with a first hole exposing the drain electrode DE. The first passivation layer 320a may include substantially a same material as a material included in the passivation layer 320.

The second passivation layer 320b is disposed on the first passivation layer 320b. The second passivation layer 320a is defined with a second hole defined corresponding to the first hole of the first passivation layer 320a. The contact hole 950 includes the first hole of the first passivation layer 320a and the second hole of the second passivation layer 320b. The second passivation layer 320b may include substantially a same material as a material included in the passivation layer 320.

The pixel electrode PE is disposed on the second passivation layer 320b. The pixel electrode PE is connected to the drain electrode DE of the switching element TFT through the contact hole 950. The pixel electrode PE illustrated in FIG. 15 may have substantially a same configuration as a configuration of one of the respective pixel electrodes PE illustrated in FIGS. 3A, 3B, 3C, and 3D.

The first alignment layer 344a is disposed on the second passivation layer 320b and the pixel electrode PE. The first alignment layer 344a may be a rubbed alignment layer or an unrubbed alignment layer.

The light blocking layer 376 defines a light emission area 111 of the pixel PX. The light blocking layer 376 is disposed in an area (i.e., a light blocking area) except the light emission area 111. For example, as illustrated in FIG. 15, the light blocking layer 376 is disposed on the second substrate 302 corresponding to the light blocking area. The light blocking layer 376 may include substantially a same material as a material included in the first light blocking layer 376a.

The color conversion layer 195 is disposed on the second substrate 302, corresponding to the light emission area 111. An edge portion of the color conversion layer 195 may be disposed on the light blocking layer 376. The color conversion layer 195 illustrated in FIG. 15 may be substantially the same as the color conversion layer 195 illustrated in FIG. 2.

The insulating layer 355 is disposed on the light blocking layer 376 and the color conversion layer 195. The insulating layer 355 may be disposed on an entire surface of the second substrate 302 including the light blocking layer 376 and the color conversion layer 195. The insulating layer 355 may be a planarization layer. The insulating layer 355 may include substantially a same material as a material included in the first insulating layer 356a.

The polarization pattern 700 is disposed on the insulating layer 355. The polarization pattern 700 includes a plurality of polarization lines 750 spaced apart from one another. The polarization pattern 700 illustrated in FIG. 15 may have substantially a same shape as a shape of the polarization pattern 700 illustrated in FIG. 2.

The common electrode 330 is disposed on the polarization pattern 700. The common electrode 330 may overlap the entirety of the polarization pattern 700. In other words, the entirety of the polarization pattern 700 may overlap the common electrode 330. For example, the common electrode 330 may overlap the plurality of polarization lines 750. In addition, the common electrode 330 may contact the plurality of polarization lines 750.

The polarization pattern 700 is disposed between the insulating layer 355 and the common electrode 330. The common electrode 330 may overlap the entirety of the polarization pattern 700. In other words, the entirety of the polarization pattern 700 may overlap the common electrode 330. For example, the common electrode 330 may overlap the plurality of polarization lines 750. In addition, the common electrode 330 may contact the plurality of polarization lines 750.

The common electrode 330 is connected to the polarization pattern 700. For example, an upper surface of the polarization pattern 700 that is opposite to an interfacial surface between the polarization pattern 700 and the insulating layer 355 may contact the common electrode 330. For example, in a case in which a surface of the polarization pattern 700 contacting the insulating layer 355 is defined as a first surface of the polarization pattern 700, and a surface of the polarization pattern 700 opposite to the first surface is defined as a second surface (i.e., an upper surface of the polarization pattern 700) of the polarization pattern 700, the second surface contacts the common electrode 330.

The entirety of the second surface of the polarization pattern 700 may contact the common electrode 330. In an alternative exemplary embodiment, a portion of the second surface of the polarization pattern 700 may contact the common electrode 330. Herein, a portion of the second surface contacting the common electrode 330 is defined as a contacting surface of the polarization pattern 700, and a portion of the second surface not contacting the common electrode 330 is defined as a non-contacting surface of the polarization pattern 700. In such an exemplary embodiment, the contacting surface of the polarization pattern 700 may have a larger area than an area of the non-contacting surface of the polarization pattern 700.

The common electrode 330 illustrated in FIG. 15 may include substantially a same material as a material included in the common electrode 330 illustrated in FIG. 2.

A hole 999 may be defined among adjacent ones of the polarization lines 750. For example, the hole 999 may be an area defined by being surrounded by adjacent ones of the polarization lines 750, the insulating layer 355, and the pixel electrode PE. The hole 999 may be filled with air.

The column spacer 472 is disposed on the common electrode 330. For example, the column spacer 472 may be disposed on the common electrode 330 to overlap the switching element TFT. The column spacer 472 and the light blocking layer 376 may be unitary. The column spacer 472 and the light blocking layer 376 may be simultaneously provided in substantially a same process.

The second alignment layer 344b is disposed on the common electrode 330 and the column spacer 472. The second alignment layer 344b may be a rubbed alignment layer or an unrubbed alignment layer.

The liquid crystal layer 333 is disposed between the first substrate 301 and the second substrate 302. For example, the liquid crystal layer 333 is disposed between the first alignment layer 344a of the first substrate 301 and the second alignment layer 344b of the second substrate 302.

The liquid crystal layer 333 may include vertically-aligned twisted-nematic (VA-TA) liquid crystals and chiral dopants.

In a case in which the LCD device includes a backlight unit 444 that emits white light, a multiplication (Δnd) of a cell gap (d) of the LCD device by a dielectric anisotropy (Δn) of the liquid crystal layer 333 may be in a range of about 270 nm to about 450 nm. The cell gap d of the LCD device may be, for example, a cell gap between the first substrate 301 and the second substrate 302. In addition, in a case in which the LCD device includes a backlight unit 444 that emits white light, the aforementioned multiplication Δnd may be about 315 nm or less. In an alternative exemplary embodiment, in a case in which the LCD device includes a backlight unit 444 that emits blue light, the aforementioned multiplication Δnd may be in a range of about 205 nm to about 300 nm.

In a case in which the LCD device includes a backlight unit 444 that emits white light, a ratio (d/p) of the cell gap d to a pitch (p) of the liquid crystal layer 333 may be in a range of about 0.20 to about 0.35. That is, the ratio d/p may be in a range of about 0.20 to about 0.35. In such an exemplary embodiment, the pitch p is a pitch reflecting an effect due to the chiral dopant, and may be about 12 μm. In an alternative exemplary embodiment, in a case in which the LCD device includes a backlight unit 444 that emits blue light, the ratio d/p may be in a range of about 0.1 to about 0.5.

Although not illustrated, the aforementioned color filter 354 may further be disposed between the color conversion layer 195 and the second substrate 302 in FIG. 15.

As set forth above, according to one or more exemplary embodiments, an LCD device may provide the following effects.

First, as a great portion of a polarization pattern contacts a pixel electrode, resistance between the polarization pattern and the pixel electrode may be reduced. Thus, the entirety of voltage may be applied intact to the pixel electrode through the polarization pattern. Accordingly, controllability of liquid crystals by the pixel electrode may be improved.

Second, as the polarization pattern contacts a common electrode, resistance of the common electrode may be reduced. Accordingly, a common signal of the common electrode may be stabilized.

Third, as a liquid crystal layer includes VA-TA liquid crystals and chiral dopants, light transmittance of the LCD device may be improved.

From the foregoing, it will be appreciated that various embodiments in accordance with the present disclosure have been described herein for purposes of illustration, and that various modifications may be made without departing from the scope and spirit of the present teachings. Accordingly, the various embodiments disclosed herein are not intended to be limiting of the true scope and spirit of the present teachings. Various features of the above described and other embodiments may be mixed and matched in any manner, to produce further embodiments consistent with the invention.

What is claimed is:

1. A liquid crystal display device comprising:
a first substrate comprising a light emission area and a light blocking area;
a switching element on the first substrate, the switching element connected to a gate line and a data line;
a first insulating layer on the gate line, the data line, and the switching element;
a polarization pattern disposed on the first insulating layer and connected to the switching element through a contact hole of the first insulating layer; and
a pixel electrode connected to the polarization pattern in the light emission area.

2. The liquid crystal display device as claimed in claim 1, wherein a portion of an upper surface of the polarization pattern contacting the pixel electrode has a larger area than an area of a portion of the polarization pattern not contacting the pixel electrode.

3. The liquid crystal display device as claimed in claim 1, wherein a contacting area between the polarization pattern and the pixel electrode is larger than a contacting area between the polarization pattern and the switching element.

4. The liquid crystal display device as claimed in claim 3, wherein the contacting area between the polarization pattern and the pixel electrode is at least two times the contacting area between the polarization pattern and the switching element.

5. The liquid crystal display device as claimed in claim 1, wherein the polarization pattern is disposed between the first insulating layer and the pixel electrode.

6. The liquid crystal display device as claimed in claim 1, wherein the polarization pattern comprises a plurality of polarization lines spaced apart from one another.

7. The liquid crystal display device as claimed in claim 6, wherein the pixel electrode overlaps the plurality of polarization lines.

8. The liquid crystal display device as claimed in claim 6, wherein the pixel electrode contacts the plurality of polarization lines.

9. The liquid crystal display device as claimed in claim 6, defined with a hole that is defined by being surrounded by adjacent ones of the polarization lines, the first insulating layer, and the pixel electrode.

10. The liquid crystal display device as claimed in claim 9, further comprising a second insulating layer in the hole.

11. The liquid crystal display device as claimed in claim 10, wherein the second insulating layer and the first insulating layer are unitary.

12. The liquid crystal display device as claimed in claim 6, wherein at least one of the plurality of polarization lines is connected to the switching element.

13. The liquid crystal display device as claimed in claim 6, further comprising a connecting electrode connecting adjacent ones of the polarization lines.

14. The liquid crystal display device as claimed in claim 6, wherein the plurality of polarization lines are substantially parallel to the data line.

15. The liquid crystal display device as claimed in claim 1, further comprising at least one of:
a color filter between the first substrate and the first insulating layer; and
a color conversion layer between the color filter and the first insulating layer.

16. The liquid crystal display device as claimed in claim 1, further comprising:
a second substrate spaced apart from the first substrate; and
a liquid crystal layer between the first substrate and the second substrate.

17. The liquid crystal display device as claimed in claim 16, wherein the liquid crystal layer comprises a chiral dopant.

18. The liquid crystal display device as claimed in claim 17, wherein a multiplication of a cell gap between the first substrate and the second substrate by a dielectric anisotropy of the liquid crystal layer is in a range of about 270 nanometers (nm) to about 450 nm.

19. The liquid crystal display device as claimed in claim 17, wherein a ratio of a cell gap between the first substrate and the second substrate to a pitch of the liquid crystal layer is in a range of about 0.20 to about 0.35.

20. The liquid crystal display device as claimed in claim 16, further comprising a backlight unit generating light, wherein the second substrate is disposed between the first substrate and the backlight unit.

21. The liquid crystal display device as claimed in claim 20, wherein the backlight unit comprises one of a white light source emitting white light and a blue light source emitting blue light.

22. The liquid crystal display device as claimed in claim 1, wherein the pixel electrode comprises:
at least two planar electrodes; and
a main connecting electrode connecting adjacent ones of the planar electrodes.

23. The liquid crystal display device as claimed in claim 22, wherein the main connecting electrode has a smaller area than an area of the planar electrode.

24. The liquid crystal display device as claimed in claim 22, wherein the pixel electrode further comprises:
at least one auxiliary electrode having a smaller area than an area of the planar electrode and substantially a same length as a length of the planar electrode; and
an auxiliary connecting electrode connecting the auxiliary electrode and the planar electrode.

25. The liquid crystal display device as claimed in claim 23, wherein the auxiliary connecting electrode has a smaller area than an area of the auxiliary electrode.

26. A liquid crystal display device comprising:
a first substrate and a second substrate spaced apart from each other;
a liquid crystal layer between the first substrate and the second substrate;
a switching element and a pixel electrode on the first substrate, the pixel electrode connected to the switching element;
a color conversion layer on the second substrate;
an insulating layer on the color conversion layer;
a polarization pattern on the insulating layer; and
a common electrode connected to the polarization pattern.

27. The liquid crystal display device as claimed in claim 26, wherein the common electrode is disposed between the polarization pattern and the liquid crystal layer.

28. The liquid crystal display device as claimed in claim 26, wherein a portion of an upper surface of the polarization pattern contacting the common electrode has a larger area than an area of a portion of the polarization pattern not contacting the common electrode.

29. The liquid crystal display device as claimed in claim 26, wherein the polarization pattern comprises a plurality of polarization lines spaced apart from one another.

30. The liquid crystal display device as claimed in claim 29, defined with a hole that is defined by being surrounded by adjacent ones of the polarization lines, the insulating layer, and the common electrode.

31. The liquid crystal display device as claimed in claim 26, further comprising a backlight unit generating light, wherein the first substrate is disposed between the second substrate and the backlight unit.
